(19) United States
(12) Patent Application Publication
(10) Pub. No.: US 2010/0004979 A1
(43) Pub. Date: Jan. 7, 2010

(54) Promotional Micro-Endorsement matching, distribution and conversion system and method

(75) Inventor: Tyrone S. Brunson, New Rochelle, NY (US)

Correspondence Address: Tyrone Brunson, 1333A North Ave. #344, New Rochelle, NY, 10804, US

(73) Assignees: Tyrone Brunson, New Rochelle, NY (US); Anyspace Systems Inc., New Rochelle, NY (US)

(21) Appl. No.: 12/493,173

(22) Filed: Jun. 27, 2009

Related U.S. Application Data
(60) Provisional application No. 61/078,684, filed on Jul. 7, 2008.

(51) Int. Cl. G06Q 30/00; G06Q 10/00; G06Q 50/00; G06Q 20/00; G10L 17/00

(52) U.S. Cl. 705/10; 705/14.19; 704/246; 704/E17.003

(57) ABSTRACT

A method and system to provide Broadcasting networks revenue by Monetizing “shout outs and holler outs”. Consumer Participants Register with Internet domain network and then issue shout outs on participating broadcasting (radio, TV . . . etc) networks. The consumers are then paid a fee for mentioning an advertiser during the shout out, if conducted in correct format.

### FIELD OF THE INVENTION

“The present invention relates generally to an endorsement based marketing system and method, and in particular, to a system and method for increasing the reach and adding liquidity to promotional consumer endorsements.”

### BACKGROUND OF THE INVENTION

Electronic use of promotional content for marketing currently has many different formats. This platform for marketing usually has at least two of three parties. The three parties are consumers, advertisers, and broadcast networks. The three parties usually exchange some kind of content electronically in many different formats. There are many different marketing platforms for promotional content, but they tend to differ on the system or method of matching content between parties or repackaging content between parties.

### DESCRIPTION OF THE PRIOR ART

Current patented, or already in use categories, for promotional content marketing:
Promotional Content Matching with incentives. This is usually where consumer gets incentive for view or selecting advertisers content.
Promotional Content Matching with consumer profile. This is usually where consumer gives personal profile and advertiser uses profile to match advertiser's content to user.
Digital Content Repackaging with promotional material. This is usually when the electronic format of content is altered to add components of advertiser's brand.
Promotional Content Repackaging with Scheduled Content Distribution; this is usually when an advertiser's content is put on a schedule to match consumers.
Promotional Content matching Customer Surveying; this is usually when a consumer survey on subjects not necessary associated with the consumer is used to match promotional content with consumers.
Advertising with Celebrity endorsements; this is usually when a celebrity is paid to endorse a product. The problem with this method is that is very expensive and hard to measure effectiveness.
   The micro-endorsement system proposed can be done by millions of people around the world. This can give statistics on the effectiveness of the endorsement through the hollerout management system because more endorses gives more data points to measure and the endorsers are users of the product. One million consumer endorsers who use the product gives more readily accessible statistical data points than giving a celebrity a million dollars to do one endorsement. Also, the popularity of the celebrity endorser may vary. In contrast the consumers endorsers are only selected if the are routine users of the product.

The current proposed system differs from all categories listed above by:
Central Focus; mainly micro-endorsements.
Sequence and type of activities and functions performed.
Publisher of the content; specifically micro-endorsers.
Our implementation of measuring conversions of observers using show case pages.
Endorsement message format has to be followed within high degree or endorsement doesn't count.

These distinctions are further elaborated on in the claims and detailed description portion of the proposed patent document.

Also, Advertising with Consumer endorsements is usually when the advertisers seeks out consumers for endorsements and pays the consumer endorser; if the consumer is not paid this has to be clearly stated in the advertisement. This is good for the advertisers but not for broadcast stations. Our system and method brings the consumers endorsers in as a marketing partner in the promotional enterprise. This helps build listeners/observers for the broadcast network. Consumer endorser partners have more incentive to call in to the broadcasting network. In order to do that they have to wait listen or watch for the proper time to call in. Also, another problem most consumer endorsements is a mismatch between endorser and product. Our system or method uses so many endorsers it aggregates the risk of having one unfavorable endorsement.

### SUMMARY OF THE INVENTION

The present invention monetizes the shout out process, by setting up a three party system built on enterprise application and integration technologies,

Most shout outs are between the broadcasting station and consumer and not monetized. Some consumers participate as paid consumer endorsers but have no agreement with station that is explicit or implied; again our system is a three party system (Advertiser, Broadcast Station/Network, and consumer endorser).

The present invention improves upon prior broadcasting consumer endorsement methods by systemizing the consumer collection and adds the three party (Advertiser, Broadcast Station/Network, and consumer endorser) participation process.

According to the present invention, rather than exclusively using celebrity endorsements, the present invention differs
Consumer endorser partners.
Reinforce broadcast network participants (listeners, viewers, observers); Adds to consumer base.
Measures the conversion on the micro-endorsements.
Template Endorsement format that can be used by any Micro-Endorser and Product.

### Definitions

| | |
|---|---|
| Promotional Consumer Partner | Consumer that applies and does micro- |
| | endorsements; A Micro-Endorser. |
| Promotional Station Partner | Employee of broadcasting network that keeps track |
| | of micro-endorsements for station and acts as point |
| | of contact for station. |
| Promotional Network Partner | DJ/On air personality helps manage micro- |
| | endorsements |
| Grammar Approval | Sponsor or promotional network party can approve or |
| | disapprove of grammar used during promotional |
| | endorsements. |
| Airtime Reseller | Company that resells Airtime for communications |
| | company. |
| Endorsement Listener | Observer of the endorsement |
| Endorsement Observer | Observer of the endorsement |
| Conversion | Metrics indicating reach and effectiveness of the |
| | endorsement. |
| Show Case Page | Web page that displays products that a micro- |
| | endorser agrees to micro-endorse on broadcast |
| | networks. |
| Micro-Endorser | A person who is generally not a celebrity, but not |
| | excluding celebrities, who is paid to hollerout or |
| | shoutout an Advertising product. |
| Product Sample Compensation | This is where the micro-endorser receives |
| | compensation in the form of a sample instead of |
| | cash. |
| Promotional Content | Spoken name of the sponsor and the hollerout.com |
| Customer Profiling | Customer fill out form indicating location and product |
| | use information |
| Micro-Endorser Survey | Survey given to Micro-Endorser to evaluate |
| | advertiser match. |
| CustomerResource | The Customer is a resource that can be used for |
| | marketing |
| Promotional Broadcasting Network | Communications network wireless or wired; TV, |
| | radio, cable . . . etc. |
| Consumer Partner Account | Account holding monies, profile, and history |
| | information for Consumer Partners. |
| Micro-Endorsement Payment | Amount paid as compensation for endorsement. |
| Promotional Network Party | The application has four parties stations, consumer |
| | partners, Advertisers, and Airtime Reseller |
| Consumer Partner Voice | Voice of Consumer Partner |
| Network Partner Voice | Voice DJ/On air personality. |
| Media Auditing | Auditing of the Endorsement for accounting purposes |
| Micro-Endorsement Evaluation | Evaluation of the Endorsement so that it fits the |
| | guidelines of Endorsement |
| Micro-Endorsement | This is minor promotional spot done over a |
| | broadcasting network where the participant is |
| | registered, evaluated, and popularity rated by a micro- |
| | computer. This form of endorsement is done for a |
| | commercial or other organization. |
| Shout outs | Verbal or written Endorsement for person, place or |
| | thing on a broadcast network |
| Holla Outs | Verbal or written Endorsement for person, place or |
| | thing on a broadcast network |
| HollerOut | Verbal or written Endorsement for person, place or |
| | thing on a broadcast network |
| Advertiser | Commercial or non-profit organization that allows the |
| | voice or visual airtime reseller to seek endorsements |
| | for Advertisers products. |

### BRIEF DESCRIPTION OF THE DRAWINGS

FIG. 1. Overview of Hollerout Micro-Endorsement network

FIG. 2. Overview of Enterprise Service Bus

FIG. 3. Content Monitoring

FIG. 4. Customer Profiling

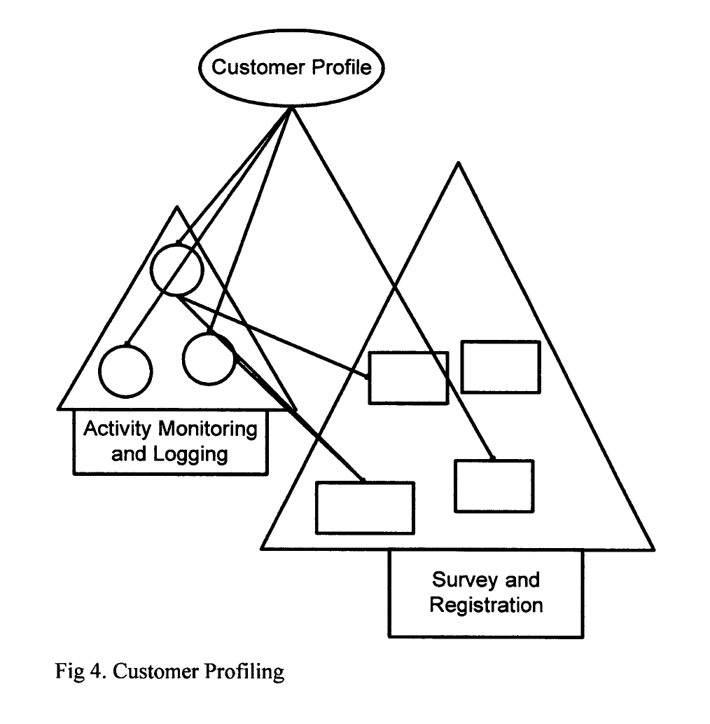

FIG. 5. CustomerResource Promotion

FIG. 6. Account Reporting

FIG. 7. Payment Assessment

FIG. 8. Party Matching

FIG. 9. Voice Matching

FIG. 10. Media Auditing

FIG. 11. Message Rating

FIG. 12. Partner Relationship Reporting

FIG. 13 Content Distribution

FIG. 14 Conversion Monitoring

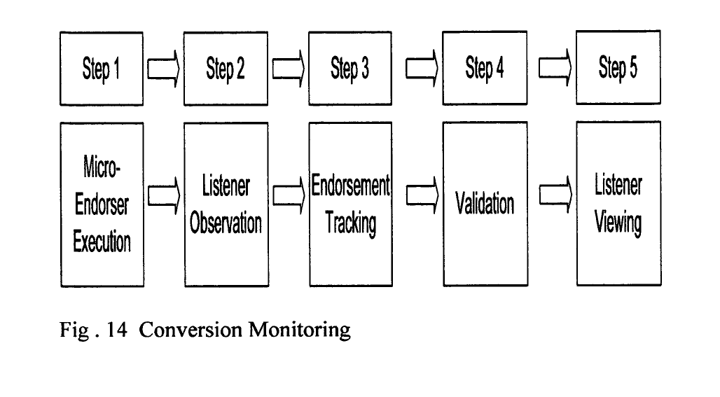

FIG. 15. Endorser Auctioning

FIG. 16. Event Matching

FIG. 17. Show Case Page Template Automation

### DETAILED DESCRIPTION OF THE PREFERRED EMBODIMENT

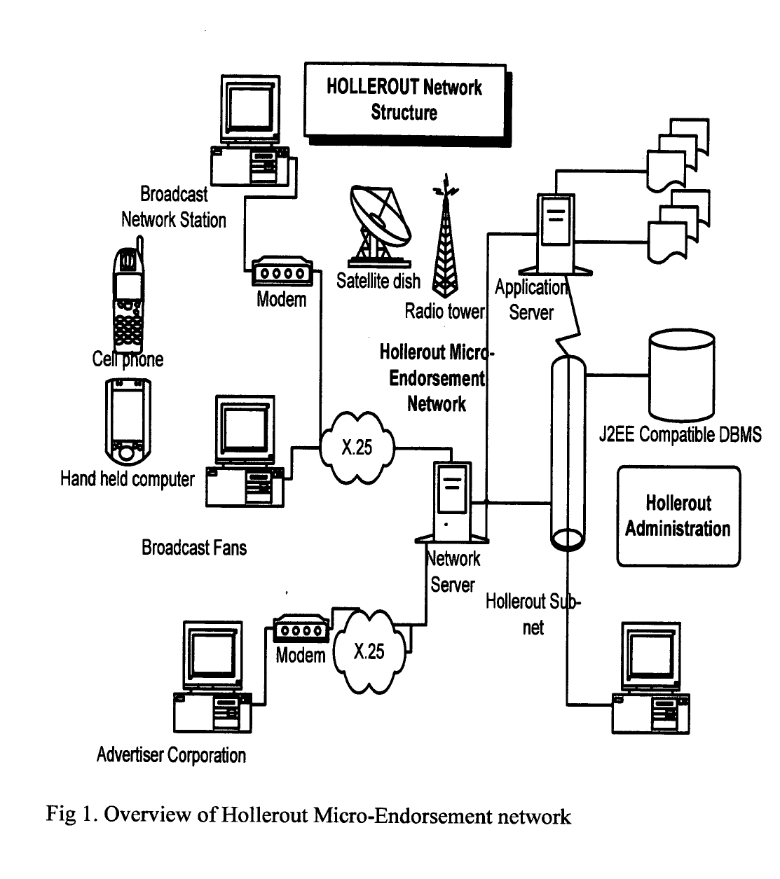

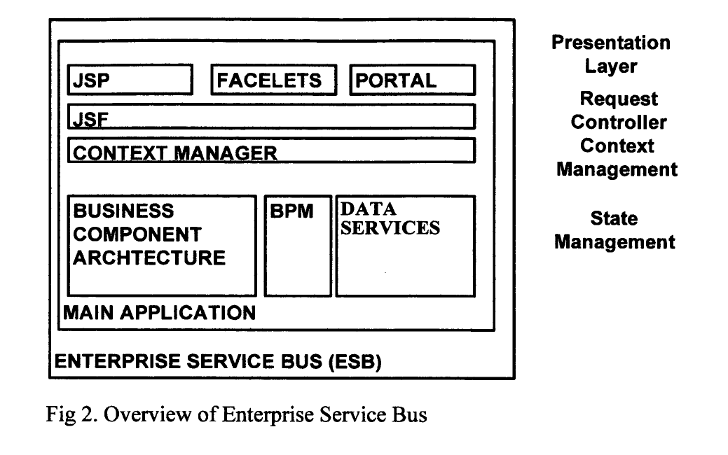

The present invention now is described more fully hereinafter with reference to the accompanying drawings, in which preferred embodiments of the invention are shown. Overview of the Hollerout Micro-Endorsement Network is illustrated in FIG. 1. The Participants use the broadcast network to issue Micro-Endorsements and then use the Internet to collaborate and manage the micro-endorsement process using Internet Browsers. The Overview of Enterprise Service Bus (ESB) is illustrated in FIG. 2

Content Monitoring

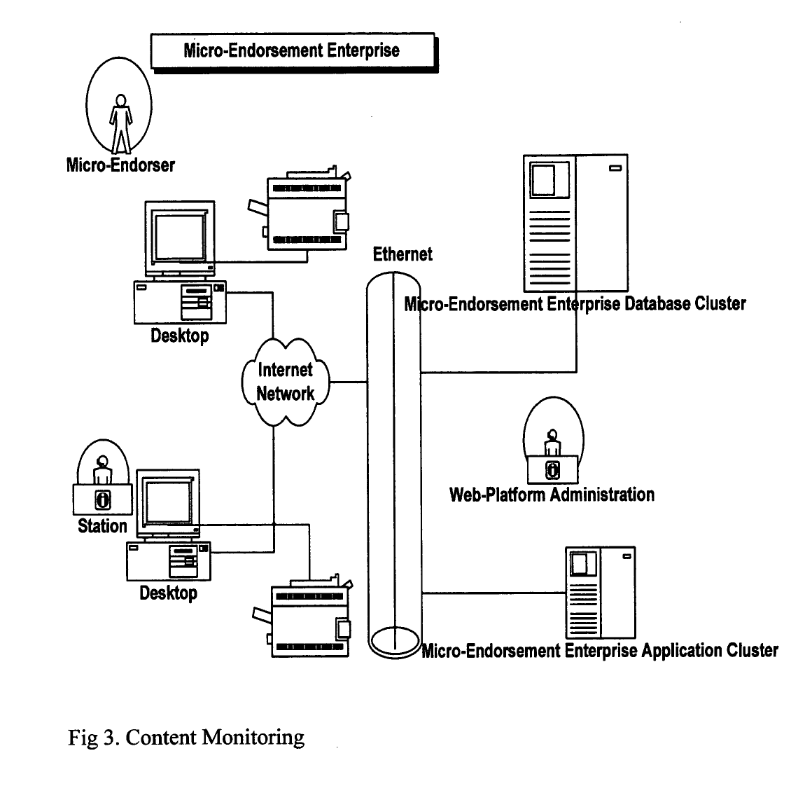

The Content Monitoring System is illustrated in FIG. 3, it checks to see if the hollerout fits the advertising customer's needs and the legal needs of the state regulatory agencies.

This subsystem proceeds to detect if the content has been changed or entered; It then does an assessment of the content; this is followed by an authentication process that issues a block on the content if authentication fails. If the content passes authentication and assessment then the content is promoted. Upon promotion, the processing and storage resources are allocated for the content. Reporting of the contents passing authentication and assessment is generated.

Customer Profiling

The Customer Profiling Subsystem is illustrated in FIG. 3; it captures the customer information through the data entry. This is entry can take the form of surveys and personal information forms. This information enhances the micro-endorsement process.

This subsystem proceeds to capture the form data; it then validates the form data which is then processed for profiling and matching. After scoring and rating the profile information the data is then marked for approval.

The benefits of the customer profiling subsystem are it's flexibility in helping with customer and advertiser matching. It is a secure and helps meet any compliance requirements.

CustomerResource Promotion

This subsystem promotes micro-endorsers according to how successful the endorsement translates to conversions. The conversions can be observer feedback, page views, advertising customer feedback.

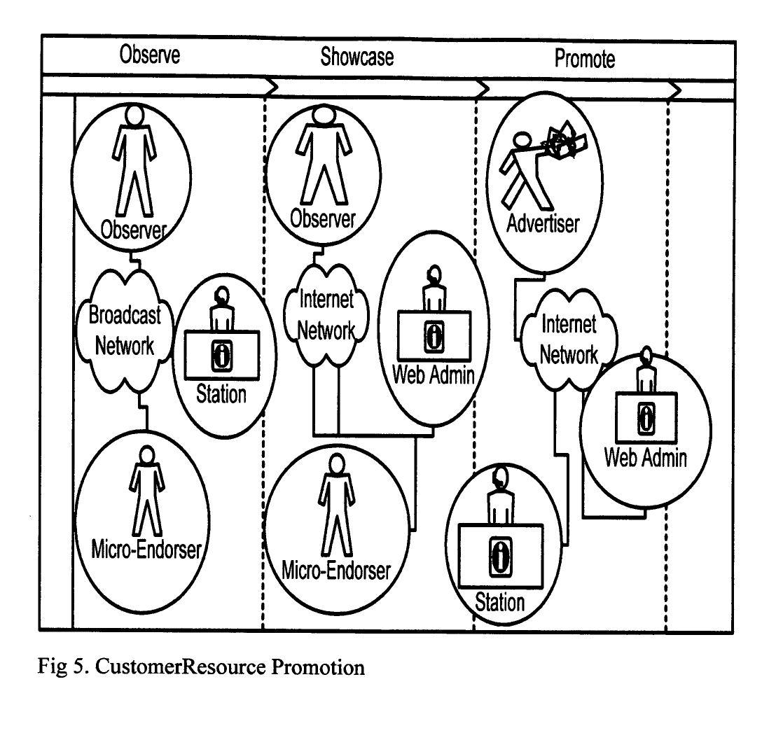

The subsystem captures conversions; then it validates the conversions. This information is stored into a database. The database information is later scanned processed by the analytics engine. The System then inserts the analytic result into the database as promotion data. Participants are advertisers, micro-endorser, and stations. The Airtime Reseller/Hollerout Administrator then reviews the data result. This is illustrated in FIG. 5.

Account Reporting

The subsystem calculates statistical and billing information to the parties. This gives, each party, information that can be used to better use the micro-endorsement system. The main parties are Advertisers, Station Managers, and Micro-Endorsers.

This subsystem captures account information from data entry and account monitoring. It then uses business intelligence analytics to make an assessment of the account. The subsystem then checks for compliance and any necessary auditing.

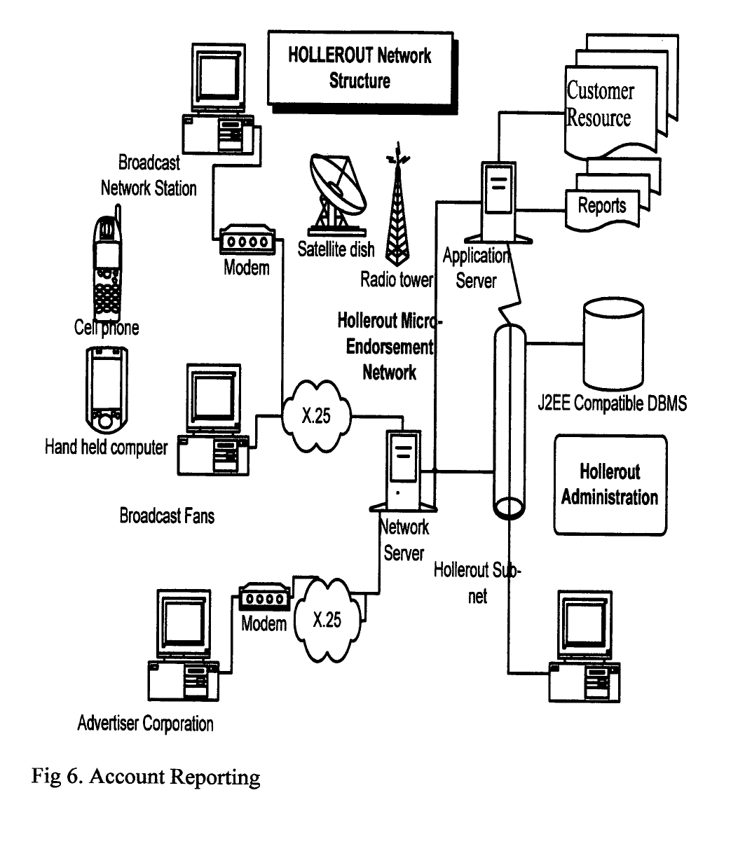

A forecast is issued and stored for the account and this information is also reported. This is illustrated in FIG. 6.

Payment Assessment

The subsystem calculates the amount to pay the station and the consumer partners by looking at the amount and percentages allocated by the advertiser. This is important because compensation is a key part of the endorsement process. The main parties are Advertisers, Station Managers, and Micro-Endorsers. The Payment Algorithm is agreed ratios from the intuitional parties (Advertisers, Station Managers).

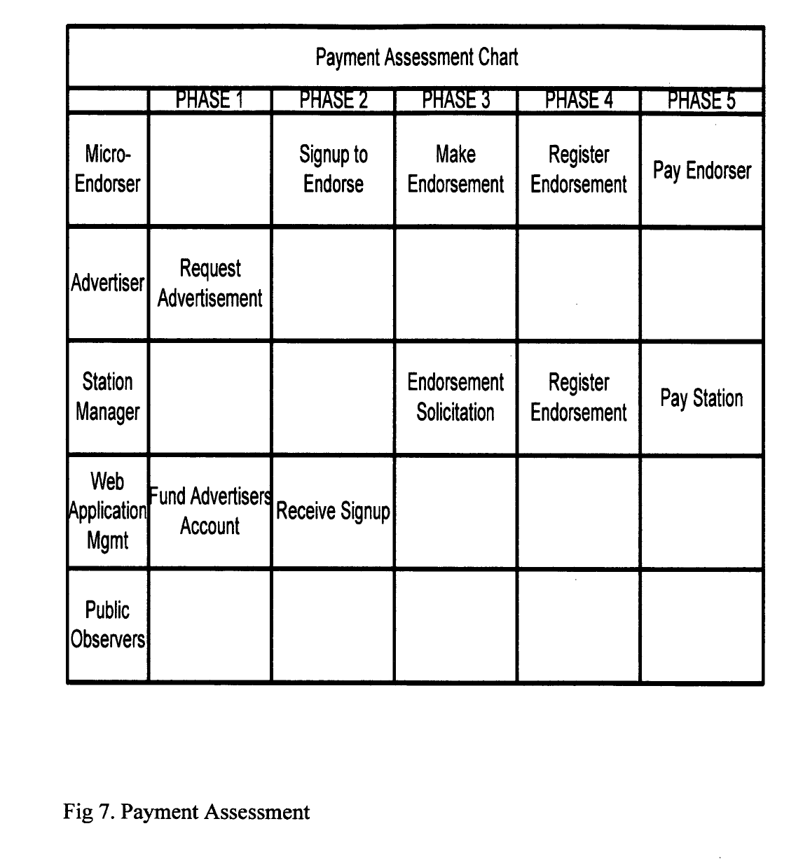

This subsystem queries the Accounts Data Services using the Business Process Management components (BPM). It then makes an assessment by first validating the business information and checking for compliance on a settlement amount. Then it routes payment to check payment systems and schedules a payment to Micro-Endorsers and Broadcast Stations. The subsystem then reports the payment through the web system and confirms distribution of payments. This is illustrated in FIG. 7.

Party Matching

This subsystem helps parties in the system find, evaluate and come together for the endorsement exchange. The Web Management system allows the main participants (Advertisers, Station Managers, and Micro-Endorsers) to find counter party participants. A Micro-Endorser is a matching counter party participant to Station Managers. A Micro-Endorser is a matching counter party participant to Advertisers. A Station Manager is a matching counter party participant to an Advertiser. This increases the probability of participation.

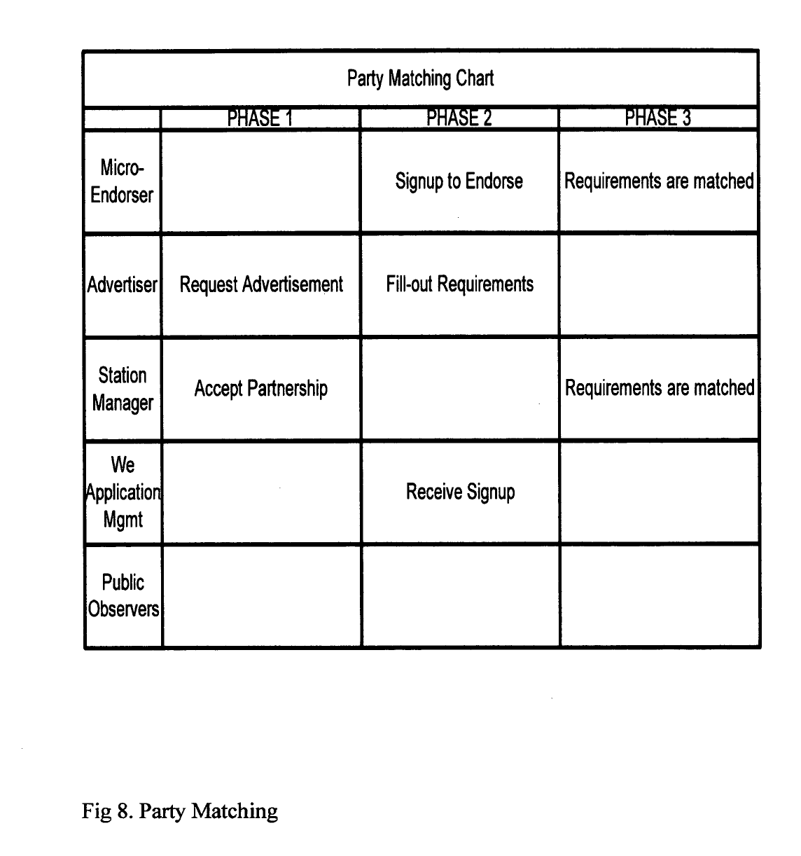

This subsystem allows participants to search for other matching counter party participants using the Web Management System. A connection is made to the Business Process Management to access business intelligence components that score participants for matching. This result is sent through Business Process Management to Data Services for later storage and analysis. Concurrently, there is a subsystem that is using analytics to improve upon the scoring assigned during matching. This is illustrated in FIG. 8.

Voice Matching

This subsystem allows the Micro-Endorser to submit sound files that can be used later to verify the Micro-Endorser. Verification of Micro-Endorser is important to the business process. The main parties are Station Managers, and Micro-Endorsers.

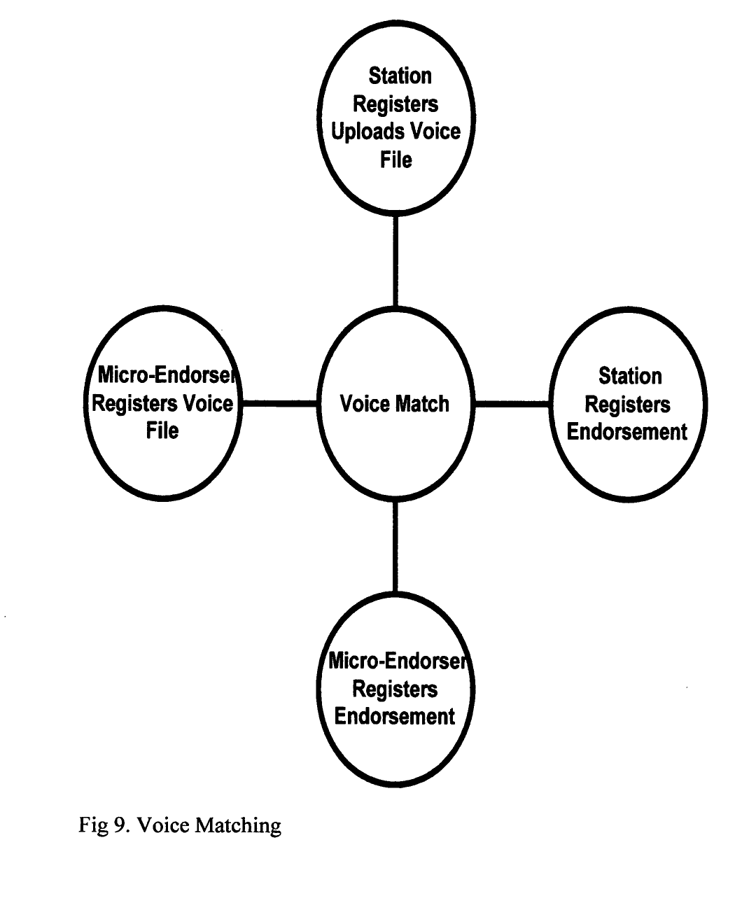

The subsystem captures digital voice files upon creation of Micro-Endorsers account. Digital voice files can be captured upon completion of Micro-Endorsement. These two files are then used to authenticate the Micro-Endorser. Concurrently, profiling information will is logged. The web processing system has a player then can be used to listen and view the digital voice file. The subsystem then allows the appropriate participants issue and log an approval. This is illustrated in FIG. 9.

Media Auditing

The system takes an audit of the number of endorsements in a given timeframe. There are constraints on the number of endorsements that can be funded by the advertisers in a given time frame. This system checks the integrity of micro-endorsements.

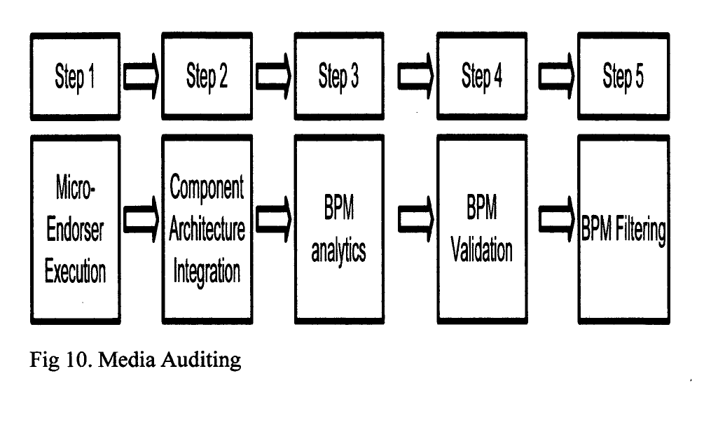

This subsystem captures the hollerout. It monitors the system for new hollerouts. The submitter of the hollerout is authenticated and the format is validated. It then audits previous and current hollerout's. The Auditing process is logged and stored. The Hollerout management company routinely confirms the audit and approves it. This is illustrated in FIG. 10.

Message Rating

The message will be rated to see if it fits the guidelines and rules of the micro-endorsement process. The Micro-Endorsement must fit certain guidelines to be creditable. Ex “I want to give a hollerout to ““IBM””and get paid”. This format has to be followed to properly credit the Micro-Endorser.

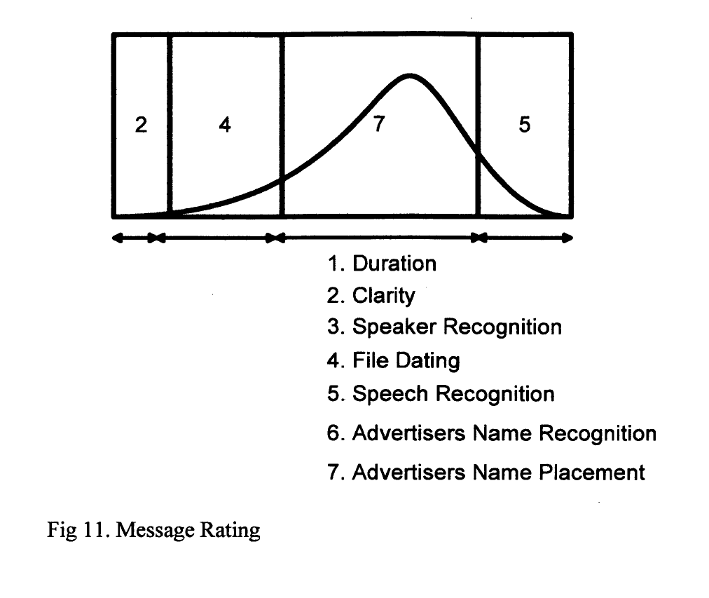

This subsystem parses the message and the key components of the message template are detected. Author of the hollerout message is validated. The message is then rated for the proper guidelines. Messages that don't fit the guidelines are filtered out. Messages that fit the guidelines are approved. This is illustrated in FIG. 11.

Partner Relationship Reporting

The System will produce reports to each party indicating how well the party relationships are performing. This allows the Hollerout management companies to better service the participants.

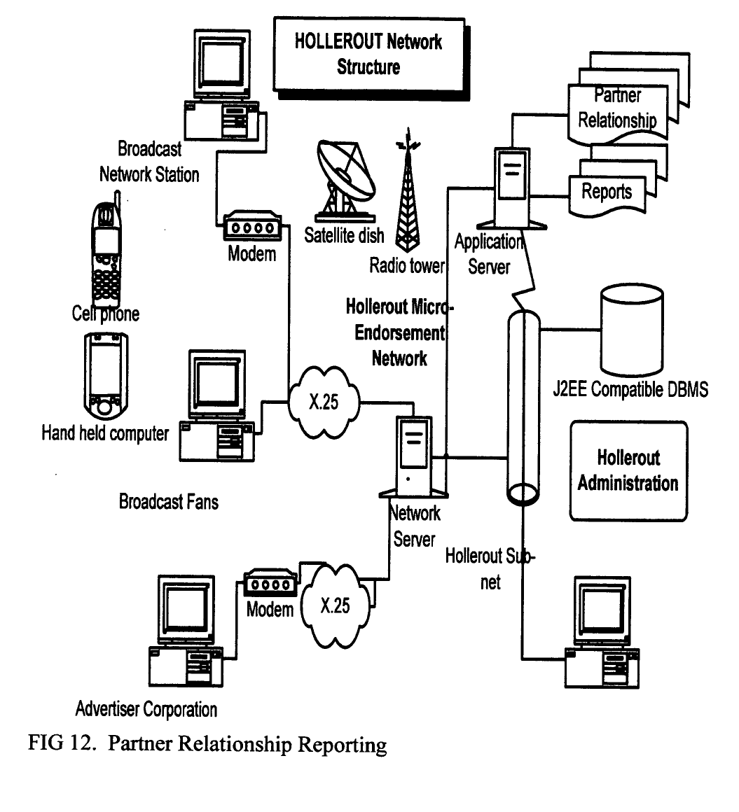

This subsystem searches for potential partnerships between participants. While searching the participant information is validated. While interacting with the Web processing platform and the Business Processing Platform the participants are monitored and profiled. An Audit is routinely done to help forecast future business relationships between participants. This is illustrated in FIG. 12.

Content Distribution

Micro-endorsers listen and view the broadcast networks and issuing micro-endorsements.

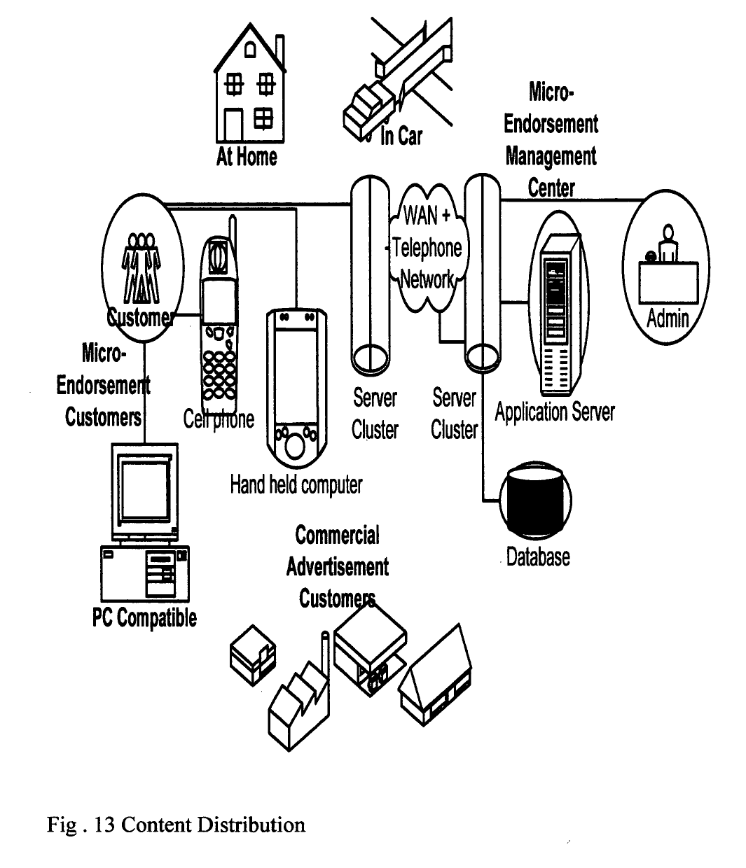

This issuing of content is done by the Content Distribution subsystem. The Micro-Endorsers first registers with the hollerout management company. The Micro-Endorser is given the template message and list of products then can endorse. The Micro-Endorser then, while listening and viewing their favorite broadcast networks, issue hollerouts in the message template format. This is illustrated in FIG. 13.

Conversion Monitoring

The process of measuring how many endorsement listeners follow-up by going to the Showcase page of the micro-endorser and viewing the product/brand is important to measure effectiveness of endorsements.

This subsystem tracks showcase page hits. It then validates the internet traffic. This web traffic information is then used to score the value of the Micro-Endorser. The subsystem then uses analytics to forecast the use of the Micro-Endorser in the future. The score and traffic information are formatted and placed in a reporting format.

Endorser Auctioning

The process where an advertiser will bid on the micro-endorser and the micro-endorser observer network, allows station managers and advertisers to increase payments due to the popularity of a Micro-Endorsers.

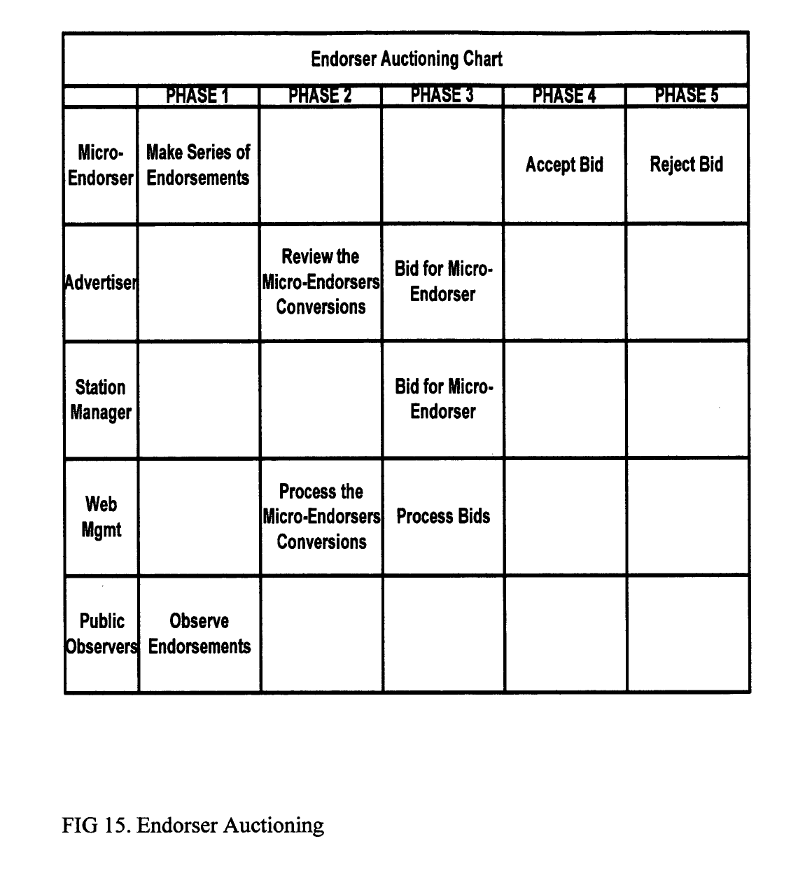

This subsystem monitors the Micro-Endorsers activities. It then does an assessment on how to promote the Micro-endorser to Advertisers for auctioning. Using the web platform an auction takes place where the Advertisers can take place. Results of the auction are then approved by both Micro-Endorsers and Advertisers. This is illustrated in FIG. 15.

Event Matching

This subsystem is the process of matching the station recorded micro-endorsement event and the micro-endorsers recorded event. Event matching is important to the contract between participants that an endorsement transaction took place.

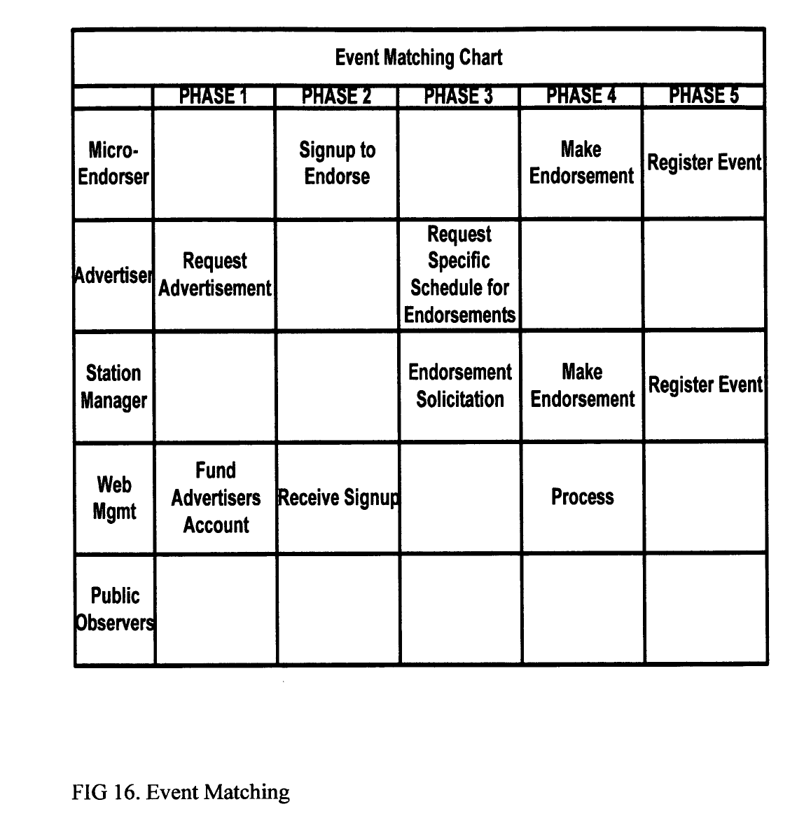

The Station Manager Participant using data entry enters information associated with the Micro-Endorsement event on the Stations network. The Micro-Endorser later, before or concurrently can enter information associated with the Micro-Endorsement event. The data entries by participants are tracked and authenticated. This information is later validated, linked and matched. Upon approval the subsystem then comes to an amount for settlement for participants. Monies are then allocated and distributed to the appropriate participants. This is illustrated in FIG. 16.

Content Validation

This Subsystem has validation rules to verify the micro-endorsement matches the Advertiser brand or product. Digital content sound files are given as proof of transaction. Content validation is associated with validation of the digital content. Attributes such as time, quality and length are checked.

This subsystem detects digital information has been submitted for validation through data entry. The digital content is tracked for changes if digital content is edited. If digital content that is not valid, it is then filtered from system and participant is notified.

Endorsers Page Personalization

The micro-endorser can do a limited amount of personalization of their showcase page. This page showcases the Micro-Endorsers use of the Advertisers product; while at the same time highlighting the product. The Advertisers content information is prominently displayed on the page.

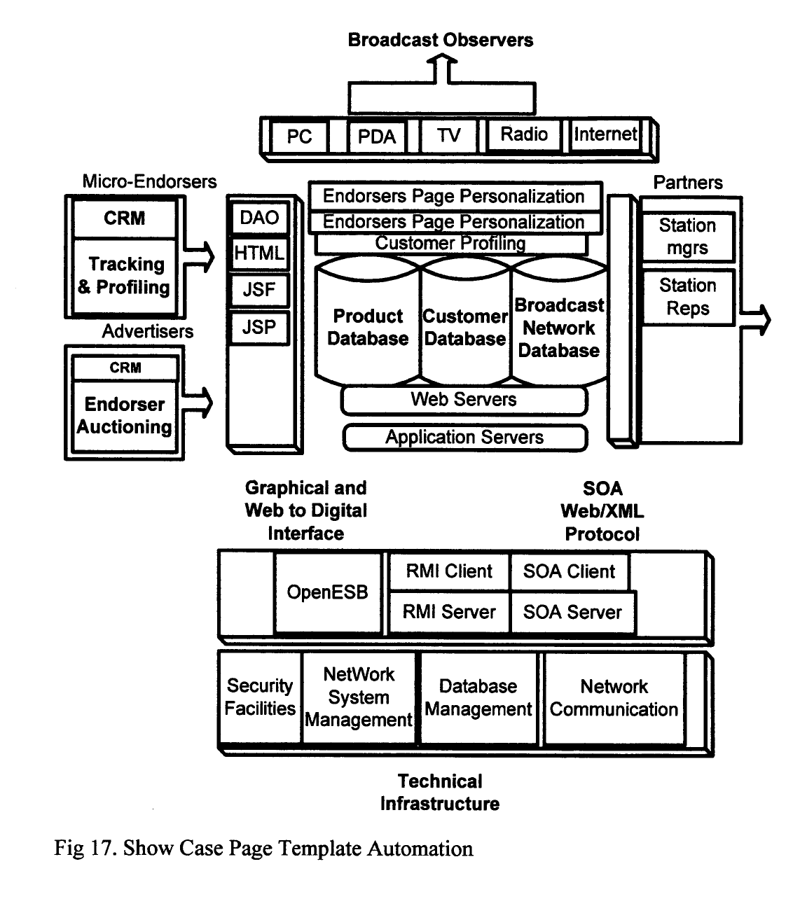

This subsystem allows Micro-Endorsers to enter personalization information through data entry. This information is authenticated and then electronically stored. Any changes are tracked and electronically logged. This logging information can be viewed using electronic reports. This is illustrated in FIG. 17.

Show Case Page Template Automation

This is the system that generates template pages that shows brief profiles of endorsers and the products they endorse. After personalization, the show case page is ready for display. The Micro-Endorsers personalization information is matched with the Advertisers digital content. Together, this information and content is integrated into a Web Markup language for presentation on the web.

This subsystem uses business intelligence to integrate Micro-Endorser information with Advertiser information. This integrated information is rendered and viewed on the web platform. Popular Showcase pages are promoted. Views of the Showcase pages are logged and reported. This is illustrated in FIG. 17.

Micro-Endorsement Grouping

Group of Micro-Endorsers work to get a product endorsed over broadcast network. To increase air-time an advertiser can coordinate with Micro-Endorsement groups.

This is the conclusion of our description of the invention. We believe we have described the invention in full detail. It should be understood that any application with reasonable variation to the detail given, still falls within the scope of the invention defined and the subjoined claims.

1. A method and system to provide broadcasting networks revenue by monetizing “shout outs/holler outs”. Consumer Participants register with Internet domain network and then issue shout outs on participating broadcasting (radio, TV . . . etc) networks. The Consumers are then paid a fee for mentioning an advertiser during the shout out.

2. A system as recited by claim 1, further comprising the step of Customer Profiling; The System profiles the consumer by taking a survey. This is important because the consumer is later matched to the appropriate product.

3. A method as recited by claim 1, wherein Network Monitoring is processed for said customer; specifically where broadcast station managers are monitoring consumer endorsement partners so that they communicate with standard broadcast communications. Also, the all three parties (Advertisers, Consumer Partners, and Station/Network managers) are monitored for use by internet registration and party matching system.

4. A system as recited by claim 2, wherein said profiling is followed by Partner Matching; specifically matching parties in our three party (Advertisers, Consumer Partners, and Station/Network managers) promotional content marketing system.

5. A method and system as recited by claim 2, Party Matching; specifically there are three parties (Advertisers, Consumer Partners, and Station/Network managers). The current system matches the three parties around the promotional content.

6. A system as recited by claim 3, further comprising the step Voice Matching specifically the system verifies the consumer partners by matching promotional content voice; to voice file given during registration.

7. A method as recited by claim 3, further comprising the step Partner Routing; specifically a system that matches broadcasting stations to advertisers based on demographics for promotional micro-endorsements.

8. A method as recited by claim 3, further comprising the step Partner Relationship Reporting; specifically the system reports on the developing relationship between parties.

9. A method as recited by claim 3, further comprising the step Content Distribution; specifically the consumer partners select potential stations they might call into; in order to distribute holler outs.

10. A system as recited by claim 3, further comprising the step Content Scheduling; specifically the consumer partners indicate which broadcast networks and scheduled shows or venues will be used to the holler out's.

11. A system as recited by claim 3, further comprising the step Media Auditing and Content Validation; media files properly assigned to parties.

12. A method as recited by claim 3, further comprising the step Message Rating; where consumer promotional content are routinely monitored for clarity.

13. A method as recited by claim 3, further comprising the step Content Monitoring; specifically the broadcasting station partners monitor the speech of the consumer partners.

14. A method as recited by claim 3, further comprising the step Grammar Monitoring; specifically the broadcasting station partners monitor the grammar the consumer partners to make sure it is valid for the micro-endorsement and the station manager submits a form indicating that the consumer partners grammar is appropriate for the station.

15. A method as recited by claim 1, further comprising the step Account Reporting; specifically the micro-endorsement system keeps track of monies being transferred between parties.

16. A method as recited by claim 15, wherein said consumer partner compensation further comprises Payment Assessment.

17. A method as recited by claim 15, wherein said consumer partner compensation further comprises Payment Distribution

18. A system as recited by claim 1; wherein Conversion Monitoring is processed for said parties; this is the process of measuring how many endorsement observers follow-up by going to the Showcase page of the micro-endorser and viewing the product/brand.

19. A method as recited by claim 3, further comprising the step Show Case Page Templating; specifically The system generates template pages that show brief profiles of Micro-Endorsers and the product they endorse. This is the page viewed by the endorsement observers.
